(19) United States
(12) Patent Application Publication
(10) Pub. No.: US 2026/0001079 A1
(43) Pub. Date: Jan. 1, 2026

(54) METHOD FOR REGULATING ARRANGEMENT OF NANOPARTICLES AT THREE-PHASE INTERFACE BASED ON MICROFLUIDIC CHIP

(71) Applicant: China University of Geosciences, Wuhan (CN)

(72) Inventors: Jingwei Huang, Wuhan (CN); Yuanping Li, Wuhan (CN); Chenyue Xie, Wuhan (CN); Zheng Cheng, Wuhan (CN); Bin Gong, Wuhan (CN); Huanquan Pan, Wuhan (CN)

(73) Assignee: China University of Geosciences, Wuhan, HB (CN)

(21) Appl. No.: 19/319,397

(22) Filed: Sep. 4, 2025

(30) Foreign Application Priority Data
Apr. 8, 2025 (CN) 202510434459.0

(51) Int. Cl. B01L 3/00

(52) U.S. Cl. CPC B01L 3/502761; B01L 2200/027; B01L 2200/0647; B01L 2200/12; B01L 2300/0663; B01L 2400/0415; B01L 2400/0487

(57) ABSTRACT

A method for regulating arrangement of nanoparticles at three-phase interface based on microfluidic chip is disclosed. The method comprises following steps: Step S1: preprocessing a microfluidic chip; Step S2: preparing three-phase fluids of water, gas and oil and injecting into fluid inlets of the microfluidic chip by utilizing high-precision injection pumps; Step S3: preparing a nanoparticle solution and injecting into a nanoparticle capture region of the microfluidic chip; Step S4: controlling arrangement and concentration of the nanoparticle solution by adjusting an electric field of the microfluidic chip; Step S5: monitoring stability of the three-phase fluids and behaviors of the nanoparticle solution at the three-phase interface in real time by utilizing a microscope and sensors; Step S6: analyzing and evaluating the data of the behaviors collected in the Step S5; and Step S7: cleaning the microfluidic chip.

### CROSS-REFERENCE TO RELATED APPLICATION

This application claims priority to Chinese Patent Application No. 202510434459.0, filed on Apr. 8, 2025, which is hereby incorporated by reference in its entirety.

### TECHNICAL FIELD

The present disclosure relates to the field of microfluidic technology and nanoparticle technology, particularly to a method for regulating arrangement of nanoparticles at three-phase interface based on microfluidic chip.

### BACKGROUND ART

In processes such as oil and gas extraction, emulsification, and gas-liquid separation, oil, gas, and water often form complex three-phase systems. Stability of the three-phase interface has a crucial influence on efficiency and effect of these processes. Specifically, the three-phase interface not only directly determines effect of the separation process, but also affects efficiency of emulsification, reaction rate, and stability of the system. In the oil-gas separation process, oil-water separation technology is based on maintaining stability of the interface between oil and water. In the emulsification process, stability of the interface between oil and water determines the particle size distribution and emulsification effect of emulsion. In gas-liquid separation processes, stability of the interface between bubbles and liquid directly affects size and distribution of the bubbles, as well as merging and bursting processes of the bubbles.

Traditional methods for controlling three-phase interface usually rely on surfactants, catalysts, or physical means to adjust stability of the interface. Surfactants and catalysts improve stability of the interface by reducing tension of the interface or promoting chemical reactions, but environmental pollution, toxicity and other issues are often appeared when the surfactants and catalysts are used. Physical means cannot precisely regulate particle distribution at the nanoscale, and effect of these physical means is strongly influenced by operating conditions, making it difficult to meet requirements of efficient and precise control. Therefore, traditional techniques often have certain limitations, especially in complex systems that require high-precision regulation of nanoparticle distribution, traditional methods are difficult to achieve ideal effects.

In recent years, nanoparticles have become an important material for studying regulation of the three-phase interface due to their excellent surface effects and high specific surface areas. Introduction of nanoparticles can generate an efficient interfacial film at the three-phase interfaces of oil, gas and water, improving the stability of the interface, reducing the tension of the interface, and optimizing the efficiency of separation and reaction processes. Especially in complex three-phase systems, surface activity of nanoparticles is significant, which can effectively adjust interactions among oil, gas, and water. Nanoparticles have significant advantages theoretically, but there are still several issues in the prior art that limit application effects of nanoparticles.

The first issue is an accuracy issue. Although traditional physical means can effectively introduce particles, they lack the ability to precisely regulate the distribution of particles at the microscopic level when the three-phase interface is regulated. Traditional methods often rely on macroscopic stirring or shear forces, making it difficult to accurately arrange and regulate distribution of the particles at the nanoscale, thereby affecting the stability of arrangement of the nanoparticles at the interface.

The second issue is an efficiency limitation. In complex three-phase systems, especially in high viscosity or inhomogeneous fluids, existing methods are difficult to ensure the stability of the interface and efficient fluid separation. For example, high viscosity fluids often lead to increased flow resistance, and traditional stirring or ultrasonic treatment methods are inefficient, making it difficult to achieve the desired stability of the interface in a short period of time. The inhomogeneous fluids make formation and regulation of the interface more complex, and existing regulation technologies often fail to address these challenges, resulting in low separation efficiency.

The third issue is a distribution and regulation issue of the nanoparticles. Some studies in existing microfluidic technologies focus on surface modification and functionalization of the nanoparticles, sorting and separation of the nanoparticles, and aggregation and stability of the nanoparticles, but these technologies are still in preliminary stage for the steady-state distribution of the nanoparticles and precise regulation of the nanoparticles at three-phase interface. Most existing microfluidic systems lack efficient and regulatable experimental devices, especially still present significant challenges in accurately regulating the arrangement and concentration of the nanoparticles at the microscale.

### SUMMARY

The purpose of the present disclosure is to provide a method for regulating arrangement of nanoparticles at three-phase interface based on microfluidic chip. Arrangement, distribution and concentration of the nanoparticles are regulated by precisely adjusting the electric field, thereby optimizing the stability of the three-phase interfaces of oil, gas and water and improving the efficiency of separation and reaction.

A method for regulating arrangement of nanoparticles at three-phase interface based on microfluidic chip is provided by the present disclosure. The method includes following steps:
in some embodiments, Step S1: preprocessing a microfluidic chip;
Step S2: preparing three-phase fluids of water, gas and oil and injecting into fluid inlets of the microfluidic chip by utilizing high-precision injection pumps to form a three-phase interface;
Step S3: preparing a nanoparticle solution and injecting into a nanoparticle capture region of the microfluidic chip;
Step S4: regulating arrangement and concentration of the nanoparticle solution by adjusting an electric field of the microfluidic chip;
Step S5: monitoring stability of the three-phase fluids and behaviors of the nanoparticle solution at the three-phase interface in real time by utilizing a microscope and sensors, and collecting data of the behaviors;
Step S6: analyzing and evaluating the data of the behaviors collected in the Step S5, and adjusting and optimizing according to analyzed and evaluated data; and
Step S7: cleaning the microfluidic chip.

In some embodiments, in the Step S1, surface cleaning, modification, and installation of the microfluidic chip are checked.

In some embodiment, in the Step S2, the fluid inlets include a first fluid inlet, a second fluid inlet, and a third fluid inlet; the first fluid inlet is connected to a high-precision injection pump containing oil, the second fluid inlet is connected to a high-precision injection pump containing water, and the third fluid inlet is connected to a high-precision injection pump containing gas.

In some embodiments, in the Step S3, the nanoparticle solution is prepared after a type of nanoparticle is selected, and the nanoparticle solution is injected into the nanoparticle capture region of the microfluidic chip by utilizing a high-precision injection pump.

In some embodiments, in the Step S4, intensity and direction of the electric field are adjusted and adjusted intensity and direction of the electric field are applied to the nanoparticle capture region.

In some embodiments, in the Step S5, the sensors include a pressure sensor, a flow rate sensor, and a temperature sensor, and a strength of the electric field, a fluid injection rate, or a concentration of the nanoparticles are regulated by monitoring the behaviors of the nanoparticle solution at the three-phase interface.

Therefore, the method for regulating arrangement of nanoparticles at three-phase interface based on microfluidic chip adopted in the present disclosure mentioned above controls arrangement, distribution and concentration of the nanoparticles by precisely adjusting the electric field, thereby optimizing the stability of the three-phase interface of oil, gas and water, and improving the efficiency of separation and reaction.

The technical solution of the present disclosure will be further described in detail through the accompanying drawings and embodiments.

### BRIEF DESCRIPTION OF THE DRAWINGS

FIG. 1 is a schematic diagram of the overall structure in the method for regulating arrangement of nanoparticles at three-phase interface based on microfluidic chip according to the present disclosure.

FIG. 2 is a schematic structural diagram of the particle capture region in the method for regulating arrangement of nanoparticles at three-phase interface based on microfluidic chip according to the present disclosure.

### DETAILED DESCRIPTION OF THE EMBODIMENTS

The technical solution of the present disclosure will be further illustrated by the accompanying drawings and embodiments.

Unless otherwise defined, the technical or scientific terms used in the present disclosure shall have the usual meanings as understood by those skilled in the art to which the present disclosure belongs.

Words such as “first”, “second” used in the present disclosure do not indicate any order, quantity, or importance, but are only used to distinguish different components. Words such as “including” or “containing” refer to “elements or objects that appear before the words cover elements or objects and their equivalents that appear after the words, without excluding other elements or objects”. Words such as “connection” or “link” are not limited to physical or mechanical connections, but can include electrical connections, whether direct or indirect. The “up”, “down”, “left”, “right”, etc. are only used to represent relative positional relationships. When the absolute position of the described object changes, the relative positional relationships may also be changed accordingly.

### Embodiment 1

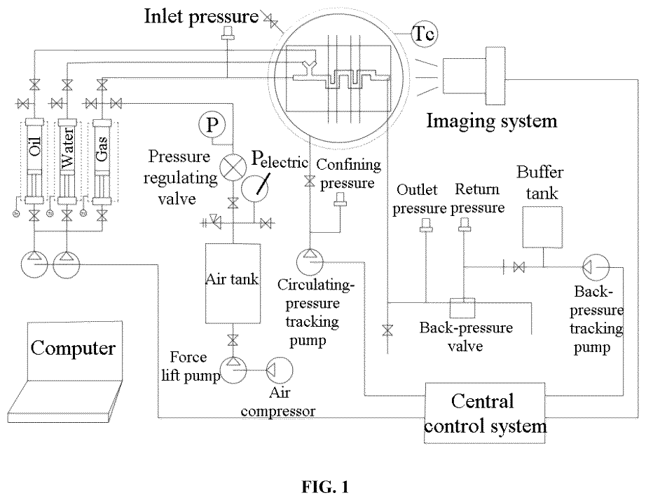

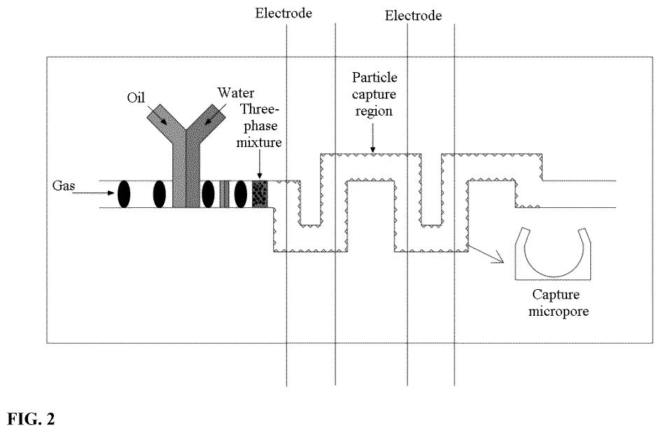

As shown in FIGS. 1-2, the method for regulating arrangement of nanoparticles at three-phase interface based on microfluidic chip provided by the present disclosure includes following Steps S1 to S7.

In Step S1, a microfluidic chip is preprocessed. And in the Step S1, surface cleaning, modification, and installation of the microfluidic chip are checked.

In Step S2, three-phase fluids of water, gas and oil are prepared and injected into fluid inlets of the microfluidic chip by utilizing high-precision injection pumps to form a three-phase interface. And in the Step S2, the fluid inlets include a first fluid inlet, a second fluid inlet, and a third fluid inlet. The first fluid inlet is connected to a high-precision injection pump containing oil, the second fluid inlet is connected to a high-precision injection pump containing water, and the third fluid inlet is connected to a high-precision injection pump containing gas.

In Step S3, a nanoparticle solution is prepared and injected into a nanoparticle capture region of the microfluidic chip. And in the Step S3, the nanoparticle solution is prepared after a type of nanoparticle is selected, and the nanoparticle solution is injected into the nanoparticle capture region of the microfluidic chip by utilizing a high-precision injection pump.

Design of the nanoparticle capture region: In the microfluidic chip, the nanoparticle capture region is a specially designed region for centralized regulation of distribution of the nanoparticles. Regulations of capture and distribution of particles are achieved via microchannels and microstructures in this region. The microchannels: The fluid flow is regulated via optimization and design of the microchannels (such as optimization and design of width, depth, and tortuosity of the microchannels), the optimization and design also make the movement and capture of the nanoparticles in the fluid more precise. The flow rate, viscosity of the fluid, and charges of the particles all can affect the efficiency of capturing the particles. The microstructures: The microstructures are designed in different shapes, such as grip shape, column shape, or sawtooth shape. These shapes can not only increase contact area between the particle and surface of the chip, but also help capture the particles via physical adsorption or electrostatic forces. For example, the designed microstructures can form stable aggregation regions, where the nanoparticles can remain stable and be further regulated by an electric field.

In Step S4, arrangement and concentration of the nanoparticle solution are regulated by adjusting an electric field of the microfluidic chip. And in the Step S4, intensity and direction of the electric field are adjusted and the adjusted intensity and direction of the electric field are applied to the nanoparticle capture region. The effect of the electric field in the nanoparticle capture region: In the nanoparticle capture region of the microfluidic chip, the electric field can be used to orient and align the nanoparticles. When an electric field is applied, charged nanoparticles will be subjected to a force of the electric field, resulting in migration. Movement path of the nanoparticles can be controlled via adjustment of the strength and direction of the electric field, clustering the nanoparticles toward specific regions. For example, the electric field can guide the nanoparticles to specific microchannels or capture structural regions.

The strength, frequency, and polarity of the electric field can all affect behaviors of the nanoparticle in microfluidic systems. A stronger force of the electric field can more quickly migrate particles to the capture region, while an appropriate frequency helps prevent aggregation or precipitation of the nanoparticles. During the capture process, the polarity of the electric field can also be adjusted to align particles in specific directions or positions. This process is achieved through the interaction between the electric field and the charges of surface of the nanoparticle. In order to ensure the uniform distribution of the nanoparticles at the three-phase interface, the design of the nanoparticle capture region not only needs to consider the adjustment of the electric field, but also needs to optimize residence time and distribution manner of particles in the nanoparticle capture region.

Adjustment of the residence time of the nanoparticles: The migration speed and residence time of particles are key factors in the capture effect. In the microfluidic chip, the residence time of the particles can be controlled by adjusting the flow rate of the fluid and strength of the electric field. A lower flow rate and a moderate strength of the electric field will allow the nanoparticles to stay in the nanoparticle capture region for a longer period of time, thus there are more opportunities to capture the nanoparticles and stabilize the nanoparticles at the interface.

Uniformity of distribution of the particles: The distribution of the nanoparticles in the nanoparticle capture region can be effectively improved by precisely adjusting the strength of the electric field and the flow rate. In high viscosity or non-Newtonian fluids, uniform distribution of the nanoparticles in the fluid can be ensured by controlling the electric field, avoiding uneven particle distribution caused by flow resistance.

In Step S5, stability of the three-phase fluids and behaviors of the nanoparticle solution at the three-phase interface are monitored in real time by utilizing a microscope and sensors, and data of the behaviors are collected. And in the Step S5, the sensors include a pressure sensor, a flow rate sensor, and a temperature sensor, and a strength of the electric field, a fluid injection rate, or a concentration of the nanoparticle are adjusted by monitoring the behaviors of the nanoparticle solution at the three-phase interface. The step of monitoring the behaviors of the nanoparticles in real time means that: a pressure sensor, a fluid sensor, a microscope and other devices are used to monitor the distribution status of particles in microfluidic channels in real time, ensuring uniform distribution of the nanoparticles in the capture region. By real-time feedback of data and adjustment of parameters such as the strength, the frequency of the electric field and the flow rate, the arrangement and concentration of the nanoparticles can be optimized. The control of the electric field can automatically adjust the parameters of the electric field to ensure that nanoparticles achieve ideal directional arrangement and concentration distribution in the target area. The dynamic adjustment capability ensures the stability and accuracy of the experimental process.

The microfluidic chip captures the nanoparticles through precisely designed microchannels and microstructures, as well as electric field control mechanisms. The electric field can not only regulate the directional arrangement of the nanoparticles, but also ensure the stability of the nanoparticles at the three-phase interface by controlling migration path, distribution status, and residence time of the nanoparticles. In addition, the integrated online monitoring and feedback system can adjust the parameters of the electric field in real time, further optimize the capture and distribution effects of the nanoparticles, and achieve precise regulation of behaviors of the nanoparticles in complex fluid systems, greatly improving the stability and separation efficiency of the three-phase interface.

The influences of the strength, the frequency, and the polarity of the electric field on the behaviors of the nanoparticles: An influence on migration and arrangement of the nanoparticles: The strength of the electric field directly determines the force of the electric field force on the nanoparticles. A stronger electric field will generate a greater force, causing the nanoparticles to migrate to a specific area of the electric field at a faster speed. In the microfluidic chip, the distribution and arrangement of the nanoparticles on the three-phase interface can be controlled by adjusting the strength of the electric field. For example, when the strength of the electric field is high, the nanoparticles may be attracted to the vicinity of the interface, forming a more concentrated arrangement; and when the strength of the electric field is small, the migration speed of the nanoparticles slows down, and the distribution of the nanoparticles in the fluid will be more uniform. An influence on the dispersion and aggregation of the nanoparticles: The changes in the strength of the electric field can also affect the dispersivity or aggregation of the nanoparticles. When the strength of the electric field is low, the electrostatic repulsion among the nanoparticles is weak, making the nanoparticles prone to aggregation; and when the strength of the electric field increases, the electrostatic repulsion among the nanoparticles increases, and the nanoparticles tend to disperse. Therefore, by precisely adjusting the strength of the electric field, the aggregation or dispersion status of the nanoparticles can be controlled, thereby affecting the stability of the three-phase interface. An influence on directional arrangement of the nanoparticles: Appropriate strength of the electric field can promote the formation of ordered arrangement of the nanoparticles at the three-phase interface. For example, at the three-phase interface of oil, water, and gas, an electric field can cause the nanoparticles to form a uniform distribution along the interface, optimizing the stability of the three-phase interface, reducing tension of the interface, and improving separation efficiency and reaction rate.

Periodic regulation of movements of the nanoparticles: The frequency of the electric field determines the frequency of the electric field force acting on the nanoparticles. When the frequency of the electric field is low, the influence of the electric field force on the nanoparticles is relatively slow, and the nanoparticles may have a longer response time. In this case, the movement of the nanoparticles is relatively stable, making it easy to control the distribution of the nanoparticles at the three-phase interface; and when the frequency of the electric field is high, the influence of the electric field force on the nanoparticles becomes more frequent, and the movement of the nanoparticles becomes more intense, which may lead to rapid dispersion or aggregation of the nanoparticles. By precisely adjusting the frequency, the nanoparticles can exhibit different dynamic behaviors at the three-phase interface, thereby affecting the stability of the three-phase interface.

The influence on the aggregation and dispersion of the nanoparticles: A high-frequency electric field usually has a stronger influence on the nanoparticles, which can effectively prevent the aggregation of the nanoparticles at the interface and maintain a more uniform distribution of the nanoparticles. However, a low-frequency electric field may cause the nanoparticles to aggregate together to form a stronger aggregate. According to experimental requirements, the behaviors of the nanoparticles can be controlled by adjusting the frequency of the electric field appropriately, improving the stability and effects of the nanoparticles at the three-phase interface.

The interaction between the nanoparticles and the interface: The changes in the frequency of the electric field can also affect the interaction between the particles and the interface. For example, in the emulsification process, the high-frequency electric field may make the nanoparticles more evenly dispersed on the oil-water interface, effectively improving the stability of emulsion; while the low-frequency electric field may guide the nanoparticles to form a more compact structure at the interface, thereby enhancing the stability and separation effect of the interface.

The orientation control of the particles: The polarity of the electric field plays a crucial role in the directional arrangement of the nanoparticles. The nanoparticles usually carry static charges, and the polarity of the electric field can affect the positive and negative polarity of the nanoparticles, thereby affecting the direction of movement of the nanoparticles. A positive-polarity electric field will cause negatively-charged nanoparticles to migrate towards the direction of the positive electrode, and vice versa. By adjusting the polarity of the electric field, the arrangement direction of the particles can be precisely controlled, making the distribution of the nanoparticles at the three-phase interface more orderly. For example, at the interface of oil, gas, and water, the nanoparticles can be aligned in a specific direction along the interface by changing the polarity of the electric field, thereby optimizing the stability of the interface.

The influence on behaviors of the nanoparticles in the fluid: The polarity of the electric fluid can also affect the behaviors of the nanoparticles in the fluid. For example, when the polarity of the electric field changes, the migration direction and velocity of the nanoparticles will also change accordingly, resulting in changes in the distribution and arrangement manners of the nanoparticles. By adjusting the polarity of the electric field, the movement of the nanoparticles in complex fluid systems can be finely controlled, avoiding the deposition or aggregation of the nanoparticles, thereby improving the stability and separation efficiency of the system.

The interaction with the three-phase interface: In a three-phase system, the polarity of the electric field can also affect the interaction between the nanoparticles and the three-phase interface of oil, gas, and water. By adjusting the polarity of the electric field, particles can be induced to aggregate or disperse at a certain interface, thereby affecting the tension and stability of the interface. For example, in the oil-water emulsification process, by adjusting the polarity of the electric field, the nanoparticles can be guided to migrate towards the oil-water interface or the oil-gas interface, thereby improving the emulsification effect.

### SUMMARY

The strength, the frequency, and the polarity of the electric field have a significant influence on the regulation of behaviors of the nanoparticles. By precisely adjusting these three parameters of the electric field, dynamic control of the nanoparticles can be achieved, including dynamic controls of arrangement, concentration, and distribution of the nanoparticles, and dynamic controls of interaction between the nanoparticles and the three-phase interface. By precisely adjusting these three parameters of the electric field, the stability of the three-phase interface can be accurately adjusted, the separation effect, emulsification effect, and reaction rate of the three-phase system of oil, gas, and water under different experimental conditions can also be optimized, thereby improving the overall efficiency and accuracy of the experiment.

In Step S6, the data of the behaviors collected in the Step S5 is analyzed and evaluated, and adjustment and optimization are performed according to the analyzed and evaluated data.

In Step S7, the microfluidic chip is cleaned.

The adjustments of the strength, the frequency, and the polarity of the electric field:

The adjustment of the strength of the electric field:

The strength of the electric field determines the magnitude of the force exerted by the electric field on the nanoparticles, thus directly affecting the migration speed, arrangement manner, and concentration distribution of the particles. The adjustment of the strength of the electric field is optimized based on the following factors.

An adjustment according to fluid viscosity and flow rate: Under different experimental conditions, the viscosity and flow rate of the fluid may affect the migration behaviors of the particles. For example, in high viscosity fluids, the migration speed of the nanoparticles is slower, thus a stronger electric field is needed to overcome the resistance of the fluid to promote the directional arrangement of the particles. On the contrary, in low viscosity fluids, a weaker electric field can effectively control the distribution and arrangement of the particles.

An adjustment according to characteristics of the nanoparticles: The size, surface charge, and shape of the nanoparticles also affect response of the nanoparticles in an electric field. Larger nanoparticles or particles with higher surface charges are more sensitive to the electric field, and distribution of them can be precisely controlled by adjusting the strength of the electric field; while smaller nanoparticles or nanoparticles with lower surface charges may require a stronger-strength electric field to ensure stable distribution and control of them in the fluid.

The adjustment manner of the strength of the electric field: The change of the strength of the electric field is achieved by adjusting the output power of the electric field source. The power of the electric field source can be finely adjusted according to experimental needs. For example, when the initial distribution of the nanoparticles is uneven, a strong electric field is required to rearrange the nanoparticles. When the nanoparticles have reached an ideal distribution status, the strength of the electric field can be reduced to maintain a stable interface.

An adjustment of the frequency of the electric field: The frequency of the electric field has a significant influence on the dynamic behaviors of the nanoparticles. The frequency of the electric field mainly determines the response speed of the nanoparticles under the action of the electric field, including the response speed of the migration, aggregation, or dispersion behaviors of the nanoparticles. The adjustment of the frequency of the electric field is based on following considerations: The frequency is adjusted according to the dynamic behaviors of the nanoparticles: The behaviors of the nanoparticles in an electric field depend on the frequency of the electric field. For example, the low-frequency electric field can promote the aggregation of the nanoparticles, while the high-frequency electric field help disperse and prevent aggregation of the nanoparticles. Therefore, when it is necessary to achieve uniform distribution of the nanoparticles or maintain a dispersed state of the nanoparticles, a higher-frequency electric field can be used; and when the particles need to gather to form a interfacial film, a lower-frequency electric field can be used. An adjustment according to the properties of interaction between the fluid and the particles: The non-Newtonian properties of the fluid, viscosity of the fluid, and the interaction force among the nanoparticles all affect the selection of the frequency of the electric field. For example, when a three-phase system containing viscous or inhomogeneous fluids is dealt with, the higher-frequency electric field help stabilize the distribution of the nanoparticles and prevent migration barriers of the nanoparticles caused by viscosity. For conventional fluids, a moderate frequency of the electric field can be chosen to regulate the behaviors of the nanoparticles.

Adjustment manner of the frequency of the electric field: the frequency of the electric field is changed by adjusting the output frequency of the electric field source. By adjusting the high-frequency or low-frequency power supply, the system can change the frequency of the electric field acting on the nanoparticles, thereby accurately regulating the dynamic behaviors of the nanoparticles. The change in frequency is real-time and can be automatically adjusted according to the monitored feedback to optimize the stability and distribution of the nanoparticles at the three-phase interface. An adjustment of the polarity of the electric field: The polarity of the electric field determines the directional effect of the electric field on the nanoparticles. That is, the polarity of the electric field determines which polarity the charged nanoparticles migrate towards. The polarity plays a crucial role in the directional arrangement of the nanoparticles and the stability of the interface. The adjustment of the polarity of the electric field is optimized based on several factors: The polarity of the electric field is adjusted according to the charge of the particles and the properties of the fluid: The nanoparticles usually carry negative or positive charges, depending on surface modification or material properties of the nanoparticles. According to the charge properties of the nanoparticles, the migration direction of the nanoparticles can be regulated by the polarity of the electric field to promote the migration of the nanoparticles to specific regions. When it is necessary to aggregate the nanoparticles towards the interface, the polarity of the electric field is adjusted to move the nanoparticles towards the target interface direction.

Adjustment of the polarity according to the stability requirements of the three-phase interface: In different three-phase interface control scenarios (such as oil-gas-water separation, emulsification, etc.), different polarities of the electric field are required to adjust the behaviors of the nanoparticles. For the oil-water emulsification process, the polarity of the electric field can promote the aggregation of the nanoparticles towards the oil-water interface or the oil-gas interface, enhancing the stability of the interface. In gas-liquid separation, an appropriate polarity of the electric field can help control the stability of the interface between bubbles and liquid, avoiding excessive merging of the bubbles.

Adjustment manner of the polarity of the electric field: By changing the polarity of the power supply (i.e. the positive and negative poles of the voltage), the polarity of the electric field can be adjusted. For example, the polarity of the power source between the positive and negative poles of the electric field can be changed by changing the polarity direction of the voltage, thereby causing the nanoparticles to move towards a specific electrode direction. In the experiment, the polarity of the electric field can be adjusted in real time, and the directional arrangement of the nanoparticles can be optimized based on feedback data. Summary: The strength, frequency, and polarity of the electric field are adjusted in real time according to experimental objectives, fluid properties, and characteristics of the nanoparticles. The strength of the electric field is mainly controlled by adjusting the power of the power supply, the frequency is adjusted by changing the frequency of the electric field source, and the polarity is changed by adjusting the polarity of the power supply. By finely adjusting these parameters, a precise control of the nanoparticles can be achieved, thereby optimizing the stability of the three-phase interface, improving separation efficiency and reaction rate. The real-time feedback mechanism of the system enables these parameters to be automatically adjusted according to the dynamic behaviors of the nanoparticles in the experiment, ensuring the stability and efficiency of the operation process.

The concentration of the nanoparticles: The concentration of the nanoparticles is a key parameter that directly affects the behaviors and distribution of the particles at the three-phase interface, thereby affecting the stability of the interface, separation efficiency, and reaction rate. The selection criteria for the concentration of the nanoparticles: Settings of the concentration of the nanoparticles usually need to be adjusted according to the following factors: The types and properties of the fluid, surface characteristics of the nanoparticles, and experimental objective. The types and properties of the fluid: Different three-phase systems (such as oil, gas, and water) have different physical and chemical properties, and the viscosity and surface tension of the fluid, and interactions of the nanoparticles will all affect the optimal concentration of the nanoparticles. In the oil-gas-water separation or emulsification process, it is usually necessary to form a stable nanoparticle film at the three-phase interface to improve separation efficiency or emulsification effect. If the concentration is too low, a sufficiently stable interfacial film may not be formed; and if the concentration is too high, the nanoparticles may aggregate with each other, resulting in uneven distribution of the nanoparticles at the interface.

The surface characteristics of the nanoparticles: The surface charge, surface functionalization degree, and particle size of the nanoparticles all affect the behaviors of the nanoparticles at the interface. For example, the nanoparticles with strong surface charges may be more likely to form a stable distribution on the interface, and in some cases, a lower concentration of the nanoparticles may be required to achieve a good stability; while when the surface modification is weak or the particle size is large, it may be necessary to increase the concentration to enhance the interfacial effect of the nanoparticles.

The experimental objective: The experimental objective (such as separation efficiency, emulsification effect, reaction rate, etc.) also affect the selection of the concentration. If the objective is to achieve an efficient three-phase separation or emulsification effect, a higher concentration of the nanoparticles may be required to enhance the stability and distribution of the nanoparticles at the interface; while if the objective is to optimize the reaction rate or improve certain specific physical and chemical processes, the concentration may vary.

Typical concentration range: In the study of oil-gas-water three-phase systems, the typical concentration of the nanoparticles generally depends on the specific application scenario. The following are some common concentration ranges: Low concentration: generally between 0.01% and 0.1%, which is suitable for applications that require small amounts of the nanoparticles for surface activity regulation or interface stability. For liquid-gas-solid three-phase fluids, lower concentrations help prevent excessive aggregation among the nanoparticles, thereby facilitating uniform distribution and directional arrangement of the nanoparticles. Medium concentration: approximately between 0.1% and 1%, which is suitable for most experimental conditions for optimizing the stability of three-phase interfaces. The medium concentration ensures sufficient number of the nanoparticles to form a stable interfacial film, and does not excessively increase the interaction among the nanoparticles to cause uneven distribution or deposition. High concentration: the high concentration is usually between 1% and 5% or higher, which is suitable for situations where a large number of the nanoparticles are required to form a strong interfacial film, such as separation or complex emulsification process in high viscosity fluid. The nanoparticles at high concentrations are more prone to aggregation, which may lead to poor dispersion and deposition of the nanoparticles. Therefore, more precise control of the strength, the frequency, and the polarity of the electric field is needed to avoid aggregation of the nanoparticles. The influence of concentration on adjustment of the electric field: In practical experiments, the adjustment of the electric field is closely related to the concentration of the nanoparticles. Lower concentrations of the nanoparticles may require a strong electric field to promote directional arrangement of the nanoparticles and enhance distribution of the nanoparticles on the interface. Higher concentrations of the nanoparticles may require a weaker strength of the electric field to avoid excessive aggregation or deposition. The relationship between concentration and the strength of the electric field: When the concentration of the nanoparticles is high, a strong electric field may cause aggregation among the nanoparticles, affecting the stability of the three-phase interface. Therefore, in this case, it is necessary to balance aggregation and dispersion behaviors of the nanoparticles by precisely adjusting the strength of the electric field. The relationship between concentration and the frequency of the electric field: Under high concentration conditions, adjustment of the frequency is also particularly important. The higher-frequency electric field helps prevent aggregation of the nanoparticles and enhance dispersivity of the nanoparticles. Under lower concentrations, lower frequencies may be sufficient to stabilize the distribution of the nanoparticles and promote the formation of the interfacial film. Selection of typical experimental concentrations: The concentration selected in the specific experiment will be optimized and adjusted according to factors such as the experimental purpose, properties of the fluid, and types of the nanoparticles. The experimental design will conduct multiple tests within these concentration ranges, and optimize the final concentration settings according to feedback data such as the stability of the interface, the distribution of the nanoparticles, separation efficiency, etc.

The typical concentration of the nanoparticles is usually between 0.01% and 5%, specifically depending on the experimental objective, the properties of the three-phase fluid, and the surface characteristics of the nanoparticles. In the experiment, the regulation of concentration is closely related to the adjustments of the strength, the frequency, and the polarity of the electric field to ensure the optimal arrangement and distribution of the nanoparticles at the three-phase interface, thereby improving the stability of the interface and separation efficiency. The correlation between concentration of the nanoparticles and parameters of the electric field: The correlation between concentration and parameters of the electric field is crucial because the concentration of the nanoparticles interacts with the strength, the frequency, and the polarity of the electric field, directly affecting the distribution and arrangement of the nanoparticles at the three-phase interface, thereby affecting the stability, separation efficiency, and reaction rate of the three-phase interface. The relationship between concentration and the strength of the electric field: The relationship between the strength of the electric field and the concentration of the nanoparticles is mainly reflected in the migration speed of the nanoparticles, the interactions among the nanoparticles, and the uniformity of the distribution of the nanoparticles in the fluid. The strength requirement of the electric field for high-concentration nanoparticles: When the concentration of the nanoparticles is high, the interaction among the nanoparticles is enhanced, and the electrostatic repulsion or attraction will be increased. This may lead to the aggregation or agglomeration of the nanoparticles, affecting the uniform distribution of the nanoparticles and the stability of the three-phase interface. Therefore, in this case, a strong electric field is required to overcome the interactions among the nanoparticles and ensure the nanoparticles maintain a uniform distribution at the three-phase interface without excessive aggregation. The adjustment of the electric field for low-concentration nanoparticles: At low concentrations, the interaction among the nanoparticles is small, and the force of the electric field is usually weak. In order to form a stable arrangement and distribution of the nanoparticles at the three-phase interface, a weak or medium strength of the electric field may be required to achieve the directional arrangement of the nanoparticles. In this case, the accuracy and frequency adjustments of the electric field are particularly important, as an excessively strong electric field may cause aggregation of the nanoparticles, while an excessively weak electric field may lead to uneven migration of the nanoparticles.

Adjustment strategy of the strength of the electric field and the concentration: At high concentrations, the migration of the nanoparticles towards the target area is usually driven by increasing the strength of the electric field, the aggregation degree is also be controlled. At low concentrations, it is more inclined to use a smaller strength of the electric field to ensure that the nanoparticles can be accurately arranged and distributed in the desired way, without excessive aggregation caused by strong forces of the electric field. The relationship between the frequency of the electric field and the concentration: The influence of the frequency of the electric field on the behaviors of the nanoparticles is mainly reflected in the aggregation and dispersion of the nanoparticles, and dynamic behaviors of the nanoparticles in the fluid. Adjustment of the frequency for high-concentration nanoparticles: At high concentrations, the selection of the frequency of the electric field is crucial in preventing aggregation of the nanoparticles. The higher-frequency electric field can enhance the dispersion of the nanoparticles and prevent the formation of large-scale aggregates among the nanoparticles. When the concentration of the nanoparticles is high, The high-frequency electric field can maintain certain dynamic behaviors of the nanoparticles in the fluid, avoiding the deposition or uneven distribution of the nanoparticles. Adjustment of the frequency for low-concentration particles: Under low-concentration conditions, the lower-frequency electric field may be sufficient to achieve directional arrangement of the nanoparticles and stable distribution of the nanoparticles in the fluid. In this case, the lower-frequency electric field can make the nanoparticles gradually gather to form a stable interfacial film. Especially in the emulsification process, the lower-frequency electric field helps the nanoparticles to form an ordered structure at the oil-water interface. The comprehensive adjustment of the frequency: By precisely adjusting the frequency of the electric field, the nanoparticles can maintain optimal dynamic behaviors under different concentration conditions. For example, under high-concentration and high-frequency electric field, the nanoparticles may be evenly distributed at the interface, while the low-frequency electric field will help to form a more stable interfacial film. Therefore, the adjustment of the frequency of the electric field not only affects the dispersion or aggregation of the nanoparticles, but also affects the directional arrangement of the nanoparticles at the interface.

The relationship between the polarity of the electric field and the concentration: The polarity of the electric field determines the directionality of charged nanoparticles, and changes in concentration can affect the response of the nanoparticles to the polarity of the electric field. The relationship between the polarity of the electric field and the concentration usually involves the directional arrangement of the nanoparticles at the three-phase interface and the stability of the interface. Adjustment of the polarity of high-concentration nanoparticles: Under high concentration conditions, the directional arrangement of the nanoparticles is usually affected by strong polarity of the electric field. The polarity of the electric field can determine the migration direction of the nanoparticles, especially at the three-phase interface, where the nanoparticles often need to be arranged along a specific direction. By adjusting the polarity of the electric field, it is possible to ensure that the nanoparticles are directionally arranged along the oil-water interface, the gas-water interface, or the oil-gas interface, thereby optimizing the stability and separation effect of the three-phase interface. Adjustment of the polarity of low-concentration particles: At low concentrations, the adjustment of the polarity of the electric field usually does not lead to rapid aggregation of the nanoparticles, but rather affects the distribution and arrangement of the nanoparticles more. In this case, the directional arrangement of the nanoparticles at the three-phase interface can be regulated by the polarity of the electric field, then the stability of the interface can be improved and the risk of deposition of the nanoparticles can be decreased. The low-concentration nanoparticles can form more uniform distribution under the action of the electric field, and optimize the structure of the interfacial film. The comprehensive adjustment of the concentration and the polarity: Adjustment of the polarity of the electric field can interact with concentration changes to precisely control the behaviors of the nanoparticles at the interface. At high concentrations, the polarity of the electric field can enhance the stability of the nanoparticles at specific interfaces, while at low concentrations, smaller changes in the polarity of the electric field can achieve ideal arrangement effect of the nanoparticles. Therefore, adjustments of the polarity of the electric field and the concentration are key factors in achieving efficient control of the nanoparticles. Summary: There is a close relationship between parameters (intensity, frequency, and polarity) of the electric field and the concentration. Under high concentration conditions, the strength and the frequency of the electric field need to be enhanced to overcome the interactions among the nanoparticles and prevent aggregation, while under low concentration conditions, weaker electric fields can achieve directional arrangement and uniform distribution of the nanoparticles. In addition, the polarity of the electric field can accurately regulate the arrangement direction of the nanoparticles according to concentration changes, optimizing the stability of the three-phase interface. By comprehensively adjusting these parameters, precise control of the nanoparticles can be achieved, thereby improving the stability, separation efficiency, and reaction rate of the three-phase interface.

Therefore, in the aforementioned method for regulating arrangement of nanoparticles at three-phase interface based on microfiuldic chip provided in the present disclosure, the arrangement, distribution, and concentration of the nanoparticles can be controlled by precisely adjusting the electric field, thereby optimizing the stability of the three-phase interface of oil, gas, and water, improving separation and reaction efficiency, and providing an efficient and stable three-phase fluid control system.

The above embodiments are only used to illustrate the technical solution of the present disclosure and not to limit it. Although the present disclosure has been described in detail with reference to the preferred embodiments, those skilled in the art should understand that modifications or equivalent substitutions can still be made to the technical solution of the present disclosure, and these modifications or equivalent substitutions cannot make the modified technical solution deviate from the spirit and scope of the technical solution of the present disclosure.

What is claimed is:

1. A method for regulating arrangement of nanoparticles at a three-phase interface on a microfluidic chip, comprising following steps:
Step S1: preprocessing a microfluidic chip;
Step S2: preparing three-phase fluids of water, gas and oil and injecting into fluid inlets of the microfluidic chip by utilizing high-precision injection pumps to form a three-phase interface;
Step S3: preparing a nanoparticle solution and injecting into a nanoparticle capture region of the microfluidic chip;
Step S4: controlling arrangement and concentration of the nanoparticle solution by adjusting an electric field of the microfluidic chip;
Step S5: monitoring stability of the three-phase fluids and behaviors of the nanoparticle solution at the three-phase interface in real time by utilizing a microscope and sensors, and collecting data of the behaviors;
Step S6: analyzing and evaluating the data of the behaviors collected in the Step S5, and adjusting and optimizing according to analyzed and evaluated data; and
Step S7: cleaning the microfluidic chip.

2. The method for regulating arrangement of nanoparticles at three-phase interface based on microfluidic chip according to claim 1, wherein in Step S1, surface cleaning, modification, and installation of the microfluidic chip are checked.

3. The method for regulating arrangement of nanoparticles at three-phase interface based on microfluidic chip according to claim 1, wherein in Step S2, the fluid inlets comprise a first fluid inlet, a second fluid inlet, and a third fluid inlet;
wherein the first fluid inlet is connected to a high-precision injection pump containing oil, the second fluid inlet is connected to a high-precision injection pump containing water, and the third fluid inlet is connected to a high-precision injection pump containing gas.

4. The method for regulating arrangement of nanoparticles at three-phase interface based on microfluidic chip according to claim 1, wherein in Step S3, the nanoparticle solution is prepared after a type of nanoparticle is selected, and the nanoparticle solution is injected into the nanoparticle capture region of the microfluidic chip by utilizing a high-precision injection pump.

5. The method for regulating arrangement of nanoparticles at three-phase interface based on microfluidic chip according to claim 1, wherein in Step S4, intensity and direction of the electric field are adjusted and adjusted intensity and direction of the electric field are applied to the nanoparticle capture region.

6. The method for regulating arrangement of nanoparticles at three-phase interface based on microfluidic chip according to claim 1, wherein in Step S5, the sensors comprise a pressure sensor, a flow rate sensor, and a temperature sensor, and a strength of the electric field, a fluid injection rate, or a concentration of nanoparticles are adjusted by monitoring the behaviors of the nanoparticle solution at the three-phase interface.
